(19) United States
(12) Patent Application Publication
(10) Pub. No.: US 2014/0265646 A1
(43) Pub. Date: Sep. 18, 2014

(54) PROPULSION DEVICE

(71) Applicant: Clinton Mitchell, Lakewood, CO (US)

(72) Inventor: Clinton Mitchell, Lakewood, CO (US)

(73) Assignee: GEOLev, Golden, CO (US)

(21) Appl. No.: 13/837,175

(22) Filed: Mar. 15, 2013

(51) Int. Cl. H02K 3/02

(52) U.S. Cl. CPC H02K 3/02
USPC 310/12.21

(57) ABSTRACT

A vehicle utilizing the force produced between two magnetic fields, a generated magnetic field and an existing magnetic field (such as the Earth's magnetic field). The magnetic fields are provided at an angle. The vehicle comprises a platform, a partially shielded tube with an interior containing an electrically charged fluid and a circulator operable to move the charged fluid around the tube thereby generating a vehicle magnetic field. The vehicle magnetic field is generated at an angle as compared to the external magnetic field, which produces a force as the cross product of the number of charges in the charged fluid times the velocity of the charges, and the strength of the external magnetic field.

### FIELD OF THE INVENTION

The present invention generally relates to a propulsion device. More particularly, the invention relates to a propulsion device configured to generate a thrust utilizing a magnetic field.

### BACKGROUND OF THE INVENTION

It is well known in the art for vehicles to utilize turbines, propellers or other engines to create thrust and movement. Airborne vehicles lose efficiency because they require moving large volumes of air to generate lift which creates losses due to the friction of that air over vehicle and engine part surfaces. Vehicles require burning expensive and environmentally unfriendly fuels, such as jet fuel. These conventional airborne vehicles can be loud thus requiring extensive insulation to have a quiet interior conducive to conversation. Further, conventional air vehicles do not allow for operation in multiple mediums, for example a single vehicle capable of operating under water, in the air or in the vacuum of space.

### SUMMARY OF THE INVENTION

A device configured to generate a thrust utilizing the earth's magnetic field is provided. The device includes a platform for supporting structure, a tube forming a closed loop, and a mechanical pump or blower. In one embodiment, the tube is filled with an electrically charged fluid, such as ions. A portion of the tube is shielded so as to contain electro-magnetic forces therein. The mechanical pump or blower is configured to move the charged fluid within the tube, through the earth's magnetic field where in the movement of the charged fluid that is orthogonal to the earth's magnetic field a thrust is generated.

A vehicle having the propulsion device described above is also provided. The vehicle may include sensors and a controller configured to adjust the amount of charged fluids within the tube, as well as change the speed at which the charged fluids flow within the tube and/or control the amount of shielding of the moving charged fluid. The controller is further configured to pivot the tube relative to the platform so as to change the vector of the thrust.

### BRIEF DESCRIPTION OF THE DRAWINGS

FIG. 1 shows an embodiment of the invention with a tube and a blower;

FIG. 2 shows an embodiment of the invention with a tube, a blower and an ion generator;

FIG. 3A-3B shows different cross-sections of the tube;

FIG. 4 is a perspective view of an embodiment of the tube;

FIG. 5 is a perspective view of yet another embodiment of the tube; and

FIG. 6 is a perspective view of the device in a vehicle configured to adjust the angular orientation of the device.

### DETAILED DESCRIPTION OF THE PREFERRED EMBODIMENTS

A device 10 for generating a thrust utilizing the earth's magnetic field is provided. The device 10 includes a tube 12 forming a closed loop, and a circulator 14. The device may be mounted to a platform 16 for supporting structure. The tube 12 may be filled with a charged fluid, such as ions (as indicated in the hatched section of the tube in FIGS. 1, 2, and 6. The circulator 14 may be a mechanical pump or a blower and is configured to move the charged fluid through the tube 12 so as to generate a magnetic field. The magnetic field is generated at an angle relative to the earth's magnetic field, thus further generating a force, also referenced herein as a thrust, propelling the platform 16.

With reference first to FIG. 1, an illustrative example of a platform 16 is provided. The platform includes a first surface 18 opposite a second surface 20. The platform 16 is shown as a generally rectangular body shaped like an automotive vehicle; however, it should be appreciated by those skilled in the art that the platform 16 is shown illustratively and that additional features may be added to the platform 16 without deviating from the scope and spirit of the invention. For instance, the platform 16 may include features to increase aerodynamics, such as a rounded front-end portion, or a fin on its back-end portion. The platform 16 may be adapted to accommodate passengers by the inclusion of a seating compartment, or may be configured to carry cargo. These examples are merely exemplary and should not be read as limiting.

The tube 12 is shown adapted to fit within a bottom recess 22 of the platform 16. The tube 12 forms a closed loop. It should also be appreciated that the orientation of the tube 12 shown in the drawings is not limiting to the scope of the invention herein. For instance, FIG. 4 provides an example of different geometrical shapes of the tube, which also serves to propel the platform 15. The tube 12 in FIG. 4 provides even force generation along opposing sides of the tube as indicted by the unshielded sides. As will be explained in detail below, the tube 12 may be located or oriented differently and still function to produce a thrust operable to move the platform 16 along a desired vector.

In a first embodiment, the tube 12 is filled with a charged fluid, or ions having a net positive or negative charge. For instance, the tube 12 may be sealed, so as to prevent ions from escaping. Thus, the tube 12 may be replaced as an entire unit. Alternatively, the tube 12 may be filled prior to the assembly of the device, or may be filled before each use. In such an application, the tube 12 may include a port 24 having a cover 26 operative to open or close the port 24. The charged fluid may be introduced into the tube 12 through the port 24 in a similar manner as filling a gas tank with gasoline.

The tube 12 includes a shielded portion 28 and an unshielded portion 30. The shielded portion 28 may form ⅕ of the circumference of the tube 12, however the shielding provided is merely exemplary and it is anticipated that the tube may be shielded otherwise. For instance, FIG. 5 shows a tube 12 wherein substantially ¾ of the tube is shielded. The tube 12 is shown as having a generally rectangular shape. However, it should be appreciated by those skilled in the art that the tube 12 may be shaped otherwise. It should also be appreciated that the diameter and length of the tube 12 may be dimensioned so as to produce a desired flow rate for the charged fluid, and thus the Figures shown herein are illustrative and not limiting.

The shielded portion 28 is configured to prevent electro-magnetic forces from interfering with/countering the electro-magnetic forces generated by the unshielded portion 30. Any electro-magnetic shield currently known and used, may be adapted for use herein, illustratively including a Faraday cage. Accordingly, the shielded portion 28 may be formed from a material such as iron, copper, steel, or any other electrically conductive material that would shield/reflect electromagnetic waves.

The interior of the tube 12 is generally a smooth surface so as to maximize the efficiency of fluids flowing within the tube 12. The tube 12 may also be configured to prevent deionization of the charged fluid flowing within the tube 12. It should be appreciated by those skilled in the art that preventing deionization increases the efficiency of the propulsion device 10 by reducing the frequency that the ion generator must be actuated, or the speed at which the ions are propelled within the tube 12. Deionization may result from a charged particle reacting with the inner surface of the tube 12, and from the product of out-gassing from the tube 12. As used herein, out-gassing refers to the act of gasses or ions escaping through the tube 12. Accordingly, the tube 12 may be configured to prevent the ions from interacting with the inner surface walls 32 of the tube 12, as shown in FIGS. 3a, and 3b. For instance, the tube 12 may be vacuumed baked so as to remove the gases from the tube, and thus will have outgassed. Alternatively, the tube may be treated with a solution 32a configured to prevent ions from interacting with the inner wall of the tube. Such materials are currently known and used in the art and illustratively include PolyBenzImidazole, Polyimide, PolyAmide-Imide, filled PTFE, PolyChloroTetraFluoroEthylene, PolyEtherEtherKetone and the like.

The circulator 14 is fluidly coupled to the tube 12. The circulator 14 is configured to move the charged fluids within the tube 12, circulating the charged fluids between the shielded and unshielded portions 28, 30. Thus, it should be appreciated by those skilled in the art that as the charged fluid flows through the unshielded portion 28, a force is generated. Specifically, the force is produced as the cross product of the earth's magnetic field vector and the direction of motion of the charged fluid as it flows through the unshielded portion 28 of the tube 12. Preferably, the circulator 14 is configured to produce a force sufficient to blow the charged fluid at a speed up to 10,000 miles per hour (as is known to be used in plasma cutting tools) but would classically be at the supersonic speeds of about 1,000 miles per hour. Any circulator 14 currently known and used in the art may be adapted for use herein, illustratively including centrifugal fans and axial flow fans and utilizing nozzles and venturi systems.

The device 10 may include a controller 34 configured to adjust the operation of the circulator 14 and the orientation of the tube 12. This may be done by adjusting the orientation of the platform 16 (such as through the use of a thruster 36) itself or the tube 12 may be rotatably mounted to the platform 12. It should be appreciated by those skilled in the art that the amount of force produced by the device is based upon the density of charged fluids within the tube 12, and the velocity of the charged fluids. In the instant case, the tube 12 is filled with a predetermined amount of charged fluid, and thus variation of the speed at which the charged fluid flows along the unshielded portion 30 will determine the amount of force produced as the earth's magnetic field is generally constant. Such a relationship may be surmised in the following equation:

\vec{F}=(q\vec{v})×\vec{B} Equation (1)

Wherein F is the force generated by the movement of the particle across the earth's magnetic field, q is the charge in coulombs of the particle(s), v is velocity of the particle in the field, and B is the strength of the magnetic field.

The controller 34 may be further configured to pivot the tube 12 or the platform 16 so as to adjust the angle at which the charged fluid passes the earth's magnetic field. In such a manner, the controller 34 is operable to tune the vector of the force, and thus propel the platform 16 in numerous directions. The device 10 may include a drive 38 configured to change the position of the tube 12 relative to the platform 16. The controller 34 may be electrically coupled to the drive 38 so as to rotate the tube 12.

With reference now to FIG. 2 the device 10 may include an ion generator 40. The ion generator 40 is configured to generate a charged fluid, such as ions. The ion generator 40 may be used to augment existing charged fluids within a tube 12 pre-loaded with a charged fluid. Alternatively, the ion generator 40 may be used to fill the tube 12 with ions. It should be appreciated by those skilled in the art that the amount of ions within the tube 12 affects “q” of the equation provided above. Accordingly, a desired force and vector, collectively “F”, may be achieved by adjusting the ion generator 40, orientation of the tube 12, and operation of the blower. The controller 34 may be further operable to actuate the ion generator 40 so as to achieve a desired amount of charge, “q” within the tube 12.

There are numerous ways in which the ion generator 40 may generate ions. In one example, the ion generator 40 may be configured to deliver a high voltage input to ionize air molecules (or other fluid molecules) within the tube 12. In another example, lasers may be used to ionize the internal fluid. Yet another example may be to produce a highly ionized fluid in an external process and contain that highly ionized fluid in the tube 12. Accordingly, it should be appreciated by those skilled in the art that the embodiments described herein are illustrative of ways in which the ion generator 40 may take form, and should not be limiting to the scope of the invention. The power required to actuate the ion generator 40 may be provided by a power supply, such as a gas or electric engine, or a battery.

The ion generator 40 is fluidly coupled to the tube 12. It should be appreciated that the introduction of additional ions into the tube 12 increases the charge density of the charged fluid in the tube 12. In one embodiment the ion generator 40 produces a negatively charged fluid containing anions by introducing excess electrons into the fluid inside the tube 12. Alternatively, the ion generator 40 may produce a positively charged fluid containing cations by removing electrons from the fluid introduced to the tube 12. The charged fluid is held at approximately atmospheric pressure, and may be generated by many atmospheric pressure plasma generation devices, such as Capacitive discharge using RF ion generator 40s. Other, known atmospheric pressure plasma generators include corona discharge ionizers and dielectric barrier discharge ionizers. However, it should be appreciated that the use of low pressure or high pressure plasma is perfectly acceptable as long as high ionization is achieved in the fluid.

The controller 34 may be configured to actuate the ion generator 40, and blower, and control the angular displacement of the tube 12 with respect to the platform 16. The controller 34 may be linked to a driving control system (not shown) such as a pedal assembly and a steering wheel or a flight stick similar to one found in the cockpit of a jet. Thus, the controller 34 may be operable to propel the platform 16 in a desired direction and at a desired speed based upon the output from the drive control system.

As shown in the figures, the device 10 may be fully integrated to function as the drive for an automotive vehicle 50. The platform 16 is shaped like an automotive vehicle body. The platform 16 may include seats, an engine housing, and a cargo space. The vehicle 50 is shown as a two passenger vehicle, and the cargo space is approximately the same size as the passenger space. However, it should be appreciated that the platform 16 may be modified for group or cargo transportation.

The vehicle 50 further includes a tube 12 forming a closed loop. The tube 12 includes a shielded portion and an unshielded portion. The shielded portion is configured to prevent electro-magnetic forces from interfering with/countering the electro-magnetic forces generated by the unshielded portion. Any electro-magnetic shields that are currently known and used may be adapted for use herein, illustratively including a Faraday cage. Accordingly, shielded portion may be formed from a material such as copper, steel, iron, and any electrically conductive/reflective material.

The tube 12 is shown as having a generally rectangular shape. However, it should be appreciated by those skilled in the art that the tube 12 may be shaped otherwise. It should also be appreciated that the diameter and length of the tube 12 may be dimensioned so as to produce a desired flow rate for the charged fluid, and thus the Figures shown herein are illustrative and not limiting.

The interior of the tube 12 is generally a smooth surface so as to maximize the efficiency of fluids flowing within the tube 12. The tube 12 may also be configured to prevent deionization of the charged fluid flowing within the tube 12. It should be appreciated by those skilled in the art that preventing deionization increases the efficiency of the propulsion device 10 by reducing the frequency that the ion generator 40 must be actuated. Deionization may result from a charged particle reacting with the inner surface of the tube 12, and from the product of out-gassing from the tube 12. As used herein, out-gassing refers to the act of gas being released by the tube 12 into the charged fluid that would increase the de-ionization (or recombination) of the charged fluid in the tube 12. Accordingly, as described above, the tube 12 may include a layer 12a formed from a material configured to prevent the ions from interacting with the inner surface walls of the tube 12, as shown in FIGS. 2a, and 2b. Such materials are currently known and used in the art and illustratively include PolyBenzImidazole, Polyimide, PolyAmide-Imide, filled PTFE, PolyChloroTetraFluoroEthylene, PolyEtherEtherKetone and the like. Alternatively, the tube 12, or a layer of the tube 12b, may be treated to prevent ions from interacting with the inner wall of the tube 12 as described above. In another embodiment, the tube includes a layer 12a formed of material configured to prevent ions form interacting with the inner surface wall of the tube 12, as well as a layer treated to prevent ions from interacting with the inner wall of the tube 12. Yet another layer 12c of the tube may be treated with a solution which prevent ions from interacting with the inner wall of the tube 12.

The vehicle 50 further includes an ion generator 40, and a circulator 14. The ion generator 40 is powered by a power supply such as a battery, a gas engine, or the like. The ion generator 40 is configured to introduce a charged fluid into the tube 12. In one embodiment, the charged fluids are ions having either a net positive or negative charge. The ion generator 40 may be used to augment existing charged fluids within a tube 12 loaded with a charged fluid. Alternatively, the ion generator 40 may be used to fill the tube 12 with ions.

The circulator 14 is fluidly coupled to the tube 12. For illustrative purposes, assume that the circulator 14 is a blower 14a and is configured to blow the charged fluids within the tube 12, circulating the charged fluids between the shielded and unshielded portions 28, 30. Thus, it should be appreciated by those skilled in the art that as the charged fluid flows through the unshielded portion 30, a force is generated. Specifically, the force is produced as the cross product of the magnetic field vector formed by the charged fluid flow through the unshielded portion 30 of the tube 12 and the external magnetic field. Preferably, the blower 14a is configured to produce a force sufficient to blow the charged fluid at a speed of up to 10,000 miles per hour (super sonic). Any blower 14a currently known and used in the art may be adapted for use herein, illustratively including centrifugal fans and axial flow fans.

The vehicle 50 includes a controller 34 configured to actuate the ion generator 40 and blower so as to produce a desired thrust. The vehicle 50 may further include a positioning drive 52 operatively mounted to the tube 12. The positioning drive 52 is configured to pivot the tube 12 with respect to the platform 16. As shown, the positioning drive 52 includes a plurality of pneumatic cylinders 52a configured to adjust the position of the tube 12 with respect to the vehicle 50. Thus, by extending one of the pneumatic cylinders 52a, the vector of the force may be adjusted to propel the vehicle in a desired direction. Thus, it should be appreciated that the vector of any force produced may be adjusted, and in such a manner the direction of the vehicle is adjusted.

The vehicle may further include a driving control system such as a pedal assembly and a steering wheel. The controller 34 is in electrical communication with the drive control system. The actuation of the pedal assembly and the steering wheel is transmitted to the controller 34, wherein the controller 34 may actuate the ion generator 40, blower and the positioning drive 52 so as to increase/decrease the charge within the tube 12, the rate at which the charged fluid flows through the tube 12, and the direction at which the force is generated. Thus, the controller 34 may be operable to propel the platform 16 in a desired direction and at a desired speed based upon the output from the drive control system.

The vehicle may further include a sensor 54 configured to detect the magnetic field in which the vehicle 50 is operating. Such sensors are currently known and used in the art and illustratively include a sensor 54 commonly referenced as a magnetometer. The sensor 54 and the controller 34 are in communication with each other. As shown in the equation above, the magnetic field will affect the force produced by the charge and velocity of the charged particle.

For example, the vehicle may operate in the Earth's magnetic field. A commonly accepted average value of the Earth's magnetic field is approximately 30 μT. The blower 14a is actuated so as to move the charged fluids at a speed of Mach 1, approximately 340 meters per second. The ion generator 40 may be actuated so as to produce a charged fluid having an ionization density of 10²⁸ charged atoms per cubic centimeter. Equation 1 represents the force produced by the charged fluid moving at an angle to the external magnetic field.

\vec{F}=(q\vec{v})×\vec{B} Equation (1)

For this illustrative example the unshielded fluid flow will be assumed to be at a right angle to the Earth's magnetic field, and the shielding will be assumed to be completely effective. Equation 2 works out the force produced by the example values.

$$\vec{F} = qv \vec{B} = {10}^{2 a} a \times \frac{340 m}{1 s} \times .0003 T = 163 N . \qquad Euqation ( 2 )$$

In operation, the air in the tube 12 is charged by the ion generator 40 forming a charged fluid, and the blower is actuated so as to move the charged fluid at a desired speed, wherein the positioning drive 52 is actuated so as to pivot the tube 12 at an angle to the external magnetic field so as to create a force in a desired vector.

The invention is not restricted to the illustrative examples and embodiments described above. The embodiments are not intended as limitations on the scope of the invention. Methods, apparatus, compositions, and the like described herein are exemplary and not intended as limitations on the scope of the invention. Changes therein and other uses will occur to those skilled in the art. For example, the vehicle may have a tube 12 filled with a predetermined amount of charged fluids so as to have a desired charge. In such an embodiment, it is conceivable that the vehicle does not include an ion generator 40, and that the desired force produced is achieved by actuation of the blower and orientation of the tube 12.

I claim:

1. A propulsion device configured to provide a thrust, the propulsion device comprising:
a platform for supporting structure;
a tube having a charged fluid, mounted to the platform, the tube forming a closed loop, the tube having a shielded portion configured to shield the shielded portion from experiencing a magnetic force; and
a circulator fluidly coupled to the tube, the circulator configured to circulate the charged ions through the tube thereby generating a thrust.

2. The device as set forth in claim 1, further including a controller configured to selectively actuate the circulator so as to control the air pressure/velocity produced by the circulator.

3. The device as set forth in claim 2, further including an ion generator fluidly coupled to the tube, the ion generator configured to generate ions, wherein the controller is further configured to selectively actuate the ion generator so as to control the amount of ions produced by the ion generator.

4. The device as set forth in claim 2, wherein the controller is further configured to rotate the tube so as to generate a thrust in a desired vector.

5. The device as set forth in claim 1, further including a power supply electrically coupled to the ion generator and the circulator.

6. The device as set forth in claim 1, wherein the tube includes at least one coating operable to reduce the rate of deionization of the charged fluid within the tube.

7. The device as set forth in claim 1, wherein the tube is configured to prevent outgassing.

8. The device as set forth in claim 1, wherein the circulator is a blower.

9. The device as set forth in claim 1, wherein the circulator is a mechanical pump.

10. A vehicle having a propulsion device, the vehicle comprising:
a platform configured to support a load,
a tube forming a closed loop, the tube filled with a predetermined amount of charged fluids, the tube having a shielded portion the shielded portion configured to shield the shielded portion of the tube from experiencing a magnetic field; and
a circulator fluidly connected to the tube, the circulator operable to circulate the charged fluids along the closed loop of the tube thereby generating a thrust.

11. The vehicle as set forth in claim 10, further including a controller configured to selectively actuate the circulator so as to control the velocity of the charged fluids.

12. The vehicle as set forth in claim 10, wherein the controller is further configured to rotate the tube so as to generate a thrust in a desired vector.

13. The vehicle as set forth in claim 10, further including a sensor configured to detect the strength of the magnetic field experienced by the vehicle, the sensor transmitting the strength of the magnetic field to the controller, the controller processing the strength of the magnetic field so as to generate a desired thrust.

14. The vehicle as set forth in claim 10, further including a power supply electrically coupled to the circulator.

15. The vehicle as set forth in claim 10, wherein the tube includes at least one coating operable to reduce the rate of deionization of the charged fluid within the tube.

16. The vehicle as set forth in claim 10, wherein the tube is configured to prevent outgassing.

17. A vehicle having a propulsion device, the vehicle comprising:
a platform configured to support a load,
a tube forming a closed loop, the tube having a shielded portion the shielded portion configured to shield the shielded portion of the tube from experiencing a magnetic field;
an ion generator fluidly coupled to the tube, the ion generator configured to introduce ions into the tube; and
a circulator fluidly connected to the tube, the circulator operable to circulate the charged fluids along the closed loop of the tube thereby generating a thrust.

18. The vehicle as set forth in claim 17, further including a controller configured to selectively actuate the circulator so as to control the velocity of the charged fluids.

19. The vehicle as set forth in claim 18, wherein the controller is further configured to selectively actuate the ion generator so as to introduce a predetermined amount of ions into the tube.

20. The vehicle as set forth in claim 17, wherein the controller is further configured to change the physical orientation of the tube so as to generate a thrust in a desired vector.

21. The vehicle as set forth in claim 17, further including a sensor configured to detect the strength of the magnetic field experienced by the vehicle, the sensor transmitting the strength of the magnetic field to the controller, the controller processing the strength of the magnetic field so as to generate a desired thrust.

22. The vehicle as set forth in claim 17, further including a power supply electrically coupled to the circulator.

23. The vehicle as set forth in claim 17, wherein the tube includes at least one coating operable to reduce the rate of deionization of the charged fluid within the tube.

24. The vehicle as set forth in claim 17, wherein the tube is configured to prevent outgassing.

25. The vehicle as set forth in claim 17, wherein the charged fluid has a net positive charge.

26. The vehicle as set forth in claim 17, wherein the charged fluid has a net negative charge.
